(19) United States
(12) Patent Application Publication
(10) Pub. No.: US 2002/0101827 A1
(43) Pub. Date: Aug. 1, 2002

(54) Method for optimizing quality of service in a data transmission session based on a predetermined level of quality of service

(75) Inventor: Thomas E. Weston, Chandler, AZ (US)

Correspondence Address: MOTOROLA, INC., CORPORATE LAW DEPARTMENT - #56-238, 3102 NORTH 56TH STREET, PHOENIX, AZ, 85018, US

(73) Assignee: Motorola, Inc.

(21) Appl. No.: 09/775,261

(22) Filed: Feb. 1, 2001

(51) Int. Cl. H04L 1/00

(52) U.S. Cl. 370/253

(57) ABSTRACT

A method for optimizing service quality of a communications session is provided. Quality of a communication network (e.g., average packet delay, packet delay variation, and the like) is monitored real time (124). If an actual service quality is less than a desired quality, the system increases the actual quality (134). If, on the other hand, the actual quality is greater than a desired quality, the system either lessens the quality (132) or maintains the higher quality (130). In any case, the customer may be appropriately charged for the actual quality of service received (140).

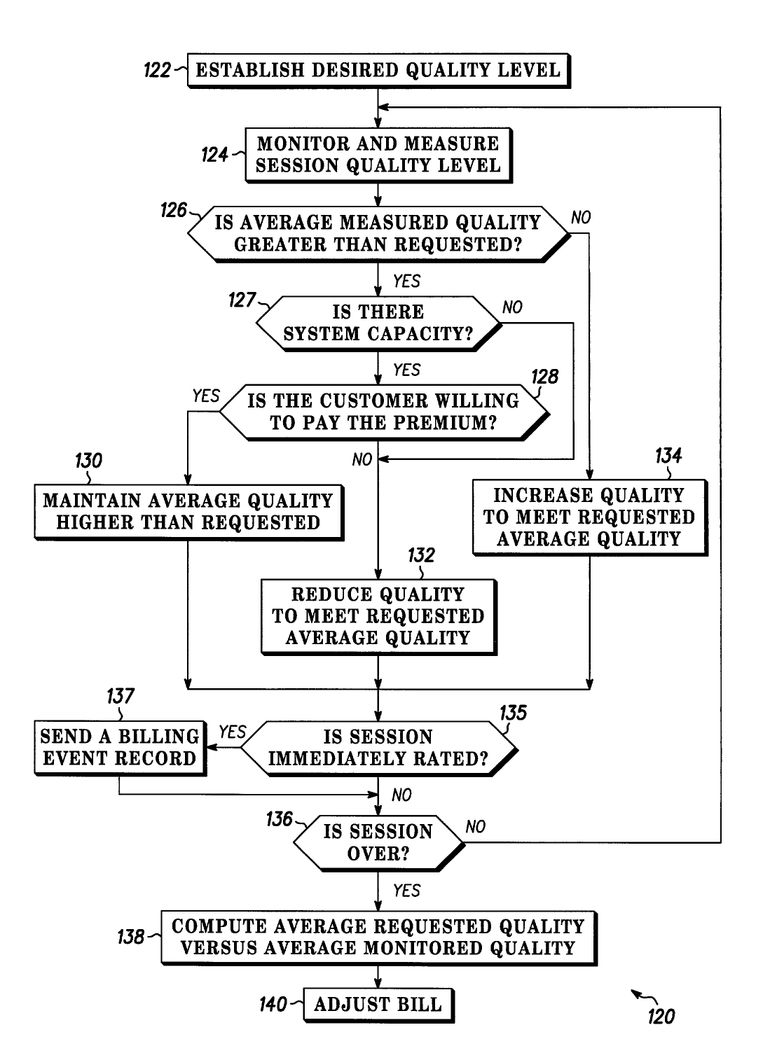

### TECHNICAL FIELD

The present invention relates, generally, to a method for collecting and utilizing quality of service metrics on a per session basis and, more particularly, to a method for allocating system resources to optimize service quality for a plurality of sessions.

### BACKGROUND ART AND TECHNICAL PROBLEMS

In both circuit-switched and packet-switched communication networks, the quality of service often effects the rate at which customers pay for data transmission services. For example, in a typical cellular telephone transmission system, a customer may agree to pay a predetermined amount of money for a predetermined number of minutes of airtime for a particular billing cycle. However, many customers will expect a discount or an additional number of “free” minutes if service quality is poor, for example, as a result of dropped calls or poor transmission quality which precludes meaningful communication. In data transmission environments, customers may pay based on the amount of data transmitted, regardless of the time required to transmit the data. These customers, too, may expect a discount or other accommodation to their bill as a result of poor quality, for example, if data packets are dropped, need to be retransmitted, or a large number of data packets are received out of order.

In an effort to maximize customer satisfaction, companies offering network and data transmission services often attempt to “quality up” a communications session to the maximum quality which the network is capable of providing, even if that quality exceeds the level of quality agreed to by the customer. Although this may be desirable in many circumstances, it is not the most efficient or profitable mode of operation. A large network can carry many more lower quality services than premium services by deliberately delaying lower quality packets or throwing them away. Providing premium service quality to all customers regardless of their request may limit the network's ability to provide premium service quality to those customers who have paid for premium quality, if network resources are diverted to provide premium quality to customers who have not paid for premium quality services.

### BRIEF DESCRIPTION OF THE DRAWING

The subject invention will hereinafter be described in conjunction with the appended drawing FIGURE, wherein the referenced numerals in the drawing FIGURE correspond to the associated descriptions provided below, and the drawing FIGURE is a is a flowchart illustrating a quality optimization method in accordance with a preferred embodiment of the present invention.

### DETAILED DESCRIPTION OF THE DRAWING

In accordance with a preferred embodiment of the present invention, the drawing FIGURE shows a method 120 for optimizing quality of a communications session. In a typical contract for communications services, for example, in the context of a cellular telephone contract, a customer contracts with a cellular provider for airtime services. Often these contracts include a desired or agreed to level of quality. Recognizing that the network cannot necessarily in all instances provide the agreed to level of quality, it may be appropriate for the provider to afford discounts to customers in those instances where the actual quality of service for a particular communications session is less than the agreed to level of quality. When a network provides a level of quality for a particular session which is greater than the level of quality that has been agreed to with a particular customer, thereby utilizing network resources for which the provider does not receive premium compensation, this may compromise the provider's ability to provide higher levels of service quality for other sessions for those customers who have agreed to pay for a premium level of quality.

In accordance with one aspect of the present invention, even if it may be possible to enhance the level of quality for a particular session above that which has been agreed to, the provider will refrain from providing an enhanced level of quality, so that network resources may be available to provide at least the agreed to level of quality for the maximum number of sessions handled by the network. In this way, instances where a level of quality which is greater than the level agreed to may be minimized, so that the maximum number of sessions may receive an agreed to level of quality.

Referring to the drawing FIGURE, a desired quality level is established between a provider and a customer, for example, through the use of a provider agreement (step 122). During a particular communications session, the quality level of the communications session is monitored, for example, in real time (step 124). In this regard, see, for example, “Quality-Based Billing System and Method For Collecting and Measuring Quality of Service Information on a Per Session Basis,” filed by the Assignee hereof on Oct. 14, 1999, in the names of Thomas Weston and Mary Madine, currently pending in the United States Patent and Trademark Office as Ser. No. 09/418,348, the entire disclosure of which is hereby incorporated by reference.

In monitoring the actual quality level of a communications session, various quality of service metrics may be monitored, depending on the nature of the communications session, the network, and the customer's needs. For example, these quality of service metrics may include: the average packet delay (APD); the packet delay variation (PDV); the number of errored packets (garbled during transmission); errored packet blocks (i.e., data blocks containing more than a predetermined number of errored packets); and the number of misinserted packets (i e., packets that were received so far out of order that they need to be discarded and resent). Of course, any subset of the foregoing metrics may be employed alone or in combination with other quality metrics, as desired for any particular implementation.

During a communications session, the average monitored level of quality is compared to the agreed to level of quality (step 126). If the average monitored level of quality is less than the agreed to level of quality (“NO” branch from step 126), the network searches for resources to increase the actual level of quality to the requested level of quality (step 134).

If, on the other hand, the average monitored level of quality exceeds the agreed to level of quality (“YES” branch from step 126), a capacity check may be performed (step 127) and the provider may either maintain the enhanced level of quality (for example, if the customer has agreed to pay for premium quality and system capacity exists), or the provider may elect to reduce the actual level quality down to the agreed to level of quality, to thereby make network resources available to optimize quality levels for other sessions.

More particularly, if the average monitored level of quality exceeds the agreed to level of quality during a particular session, the provider may wish to determine whether this particular customer has agreed to pay for premium quality (step 128). If so, (“YES” branch from step 128), the provider would maintain the quality level which is higher than agreed to (step 130), and the provider may reflect a surcharge for this premium quality level on the customer's bill. If, on the other hand, the customer has not agreed to pay for premium quality (“NO” branch from step 128), the provider may wish to decrease the quality of the communications session (step 132) down to the agreed to quality level.

A check is performed (step 135) to determine if the session is immediately rated. For sessions that use some form of immediate billing (i.e., pre-paid credit card, etc.) a billing event record is sent (step 137)

The system then checks to determine if the session is over (step 136): if not (“NO” branch from step 136), the system returns to step 124 and continues to monitor the actual quality level of the session (step 124). When the session is over, (“YES” branch from step 136), the provider's billing system compares the average requested quality level versus the average monitored quality level for the entire session (step 138). The system then makes any appropriate adjustments to the bill (step 140), depending on such factors as the terms and conditions of the service contract, the network's ability to deliver the agreed to level of quality during the session, the network's ability to deliver premium quality services during the session and other appropriate factors.

Although the present invention has been described with reference to the drawing FIGURE, those skilled in the art will appreciate that the scope of the invention is not limited to the specific forms shown in the FIGURE. Various modifications, substitutions, and enhancements may be made to the descriptions set forth herein, without departing from the spirit and scope of the invention which is set forth in the appended claims.

What is claimed is:

1. A method for optimizing a level of actual quality during a communications session, comprising the steps of:
establishing a desired quality level;
monitoring an actual quality level of the communications session;
determining whether an average monitored quality level exceeds the desired quality level;
increasing the actual quality level to the desired quality level of the communications session if the monitored actual quality level is less than the desired quality level; and
reducing the actual quality level to the desired quality level if the monitored actual quality level is greater than the desired quality level.

2. The method of claim 1, further comprising the step of generating an adjusted billing statement reflecting any increases or decreases in the actual quality level from the desired quality level.

3. The method of claim 1, wherein said monitoring step includes monitoring one or more of the following:
average packet delay;
packet delay variation;
number of error packets;
number of error packet blocks; and
number of misinserted packets.

4. The method of claim 1, wherein said increasing step includes the step of increasing the actual quality level to the desired quality level of the communications session, if the monitored actual quality level is equal to the desired quality level.

5. The method of claim 1, wherein said reducing step includes the step of reducing the actual quality level to the desired quality level of the communications session, if the monitored actual quality level is equal to the desired quality level.
